(19) United States
(12) Patent Application Publication
(10) Pub. No.: US 2006/0096544 A1
(43) Pub. Date: May 11, 2006

(54) Mat/bowl horse and livestock feeder

(76) Inventor: Mark William Spiwak, Sherman Oaks, CA (US)

Correspondence Address: JAMES R. THEIN, 2231 CRYSTAL DRIVE, SUITE 105, ARLINGTON, VA, 22202, US

(21) Appl. No.: 10/975,611

(22) Filed: Oct. 28, 2004

(51) Int. Cl. A01K 5/01

(52) U.S. Cl. 119/61.5

(57) ABSTRACT

The invention of the mat/bowl horse and livestock feeder is a feeding device that secures a feed bowl in place so that it cannot be moved, flipped or tipped as a horse or livestock feeds from it. It's a large rubber mat with a bowl attached at one end. The animal's weight on the mat portion of it prevents it from moving and stabilizes the bowl in place, securing the contents in the bowl as the animal feeds.

### BACKGROUND OF THE INVENTION

Horses and livestock are often given feed and supplements in a container, such as a bowl, pan or bucket. An issue with this is that the container is easily moved or knocked over when the large animal feeds from it, causing the feed to be spilled, wasted, covered in dirt or strewn about. There are secured containers for feeding horses and livestock that are mounted on a wall, fence, post or rail to secure it in place. There are also feed bags that are designed to fit over a horse's mouth with a strap that secures it to the horse's head. However, there aren't any horse or livestock feeders that are self-stabilizing and that don't require securing to an immovable object.

There are two existing types of mat and bowl combination feeders that are designed for in home use with smaller animals, U.S. Pat. No. 2,813,509, Animal feeding device, and U.S. Pat. No. 4,907,539, Pet food bowl and mat. Neither of the aforementioned U.S. Patents have a bowl permanently attached to the mat and both are small and not intended for horses or livestock. Another type of feeder designed for livestock is U.S. Pat. No. 95,280, Feed trough, however, it does not have a mat and it needs to be mounted to a solid surface using fasteners.

The mat/bowl horse and livestock feeder is designed specifically for these large animals. The objective of it mat/bowl horse and livestock feeder is that it stabilizes the bowl in place as the animal feeds from it, using the animals own weight.

Some of the benefits include:

Saves money: Owners spend lots of money on feed and supplements for their horses and livestock to make sure their animals are getting the necessary nutrition, vitamins, minerals, medication, etc. The mat/bowl horse and livestock feeder will eliminate waste feed by keeping it in the bowl so it can be fully ingested by the animal.
It helps prevent potential health risks to horses and livestock: Colic is a common health issue caused by ingesting sand or dirt. The mat/bowl horse and livestock feeder prevents the feed from being spilled onto the ground, preventing the unnecessary ingestion of sand or dirt.
Long-term benefits: Animals feeding in a natural grazing position helps them release natural endorphins that can have long-term health benefits for them.

A prototype has been created, comprised of an oval shaped rubber mat, approximately 40 inches wide by 44 inches long and a 16 inch diameter rubber bowl attached at one end of the mat. It's secured with five fasteners that screw into tee nuts on the underside of the mat. The prototype was first tested on a horse in Agoura, Calif. on Oct. 23, 2004. The results of the test met all of the following objectives; the horse was not able to move, flip or tip the bowl while feeding, the feed remained in the bowl and the horse's front legs remained on the mat as it accessed the feed in the bowl.

### BRIEF SUMMARY OF INVENTION

The invention of the mat/bowl horse and livestock feeder is a self-stabilizing feeder created so that a horse or livestock will not move, tip or flip the bowl while feeding from it. If the animal pushes on the bowl, it will not slide, if the animal pulls on the bowl with it's mouth, it will not angle or tip, if the animal steps on or kicks the bowl, the pliable material flexes and maintains its shape.

The surface area of the mat and location of the bowl causes animal feeding from it to stand on the mat portion with its front legs in order to access the feed in the bowl. The animal's weight secures the mat/bowl in place, therefore preventing the bowl from moving.

There are two ways the mat/bowl horse and livestock feeder can be produced. The first way is similar to how the prototype was developed where the rubber mat and bowl were independent pieces, and then fastened together using nuts and bolts. A second way it can be produced is from a single mold of the complete mat and bowl combination. Using a mold of the mat/bowl horse and livestock feeder, it can be formed from rubber using an injection process. Using this production method, there's no additional assembly required and it will be in its final form.

Some of the important qualities of the mat/bowl feeder are that it's durable, weather resistant, crush proof and will not crack or break, given the flexible, pliable material of its composition. The advantage of the mat/bowl is that the animal's weight on the mat secures bowl in place. The primary benefits include savings on wasted feed, the prevention of potential health issues caused from the ingesting dirt or sand and the feeding method that keeps the animal in a natural grazing position while feeding.

### BRIEF DESCRIPTION OF THE SEVERAL VIEWS OF THE DRAWINGS

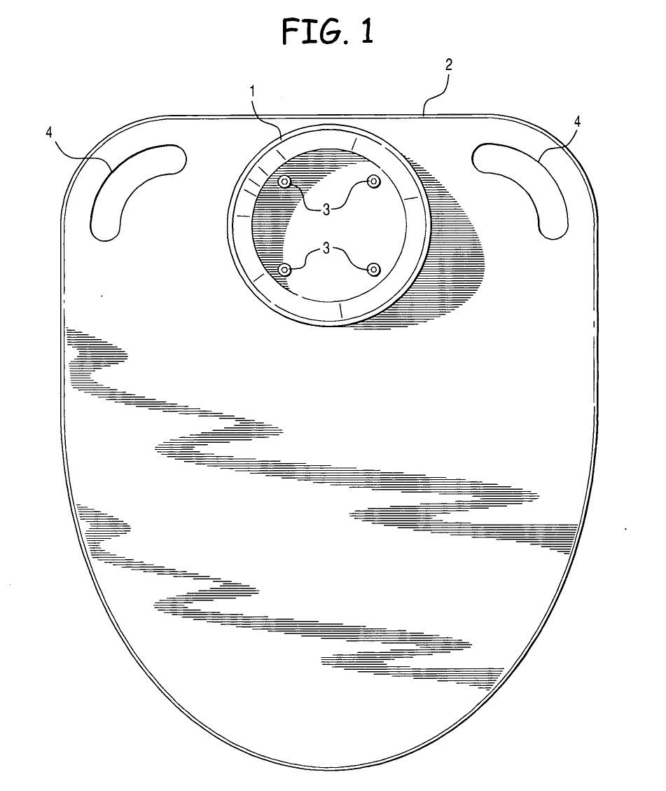

Top View (FIG. 1)—This view is looking down at the mat/bowl feeder, showing the outline and approximate dimensions of the mat 1 and the location of the bowl 2.

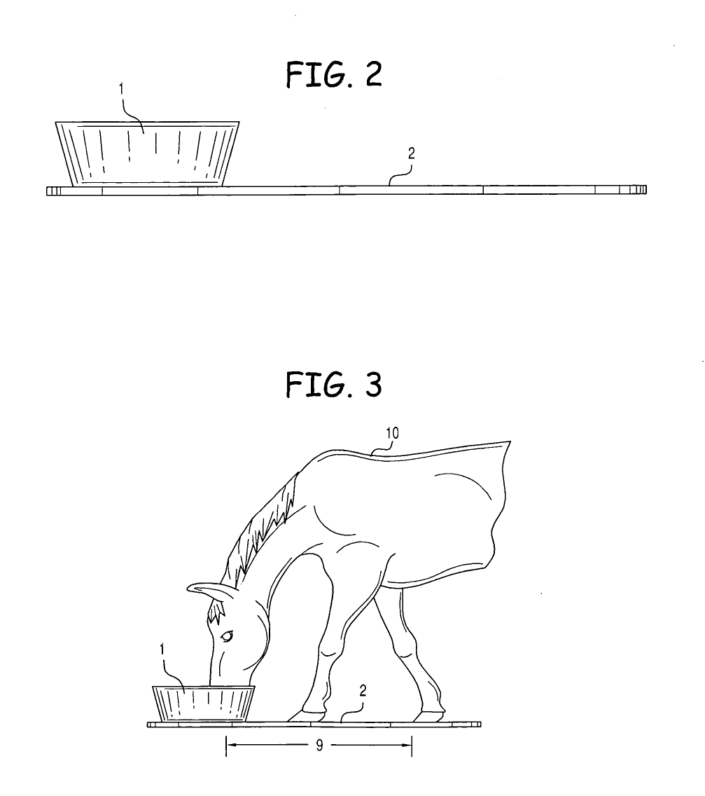

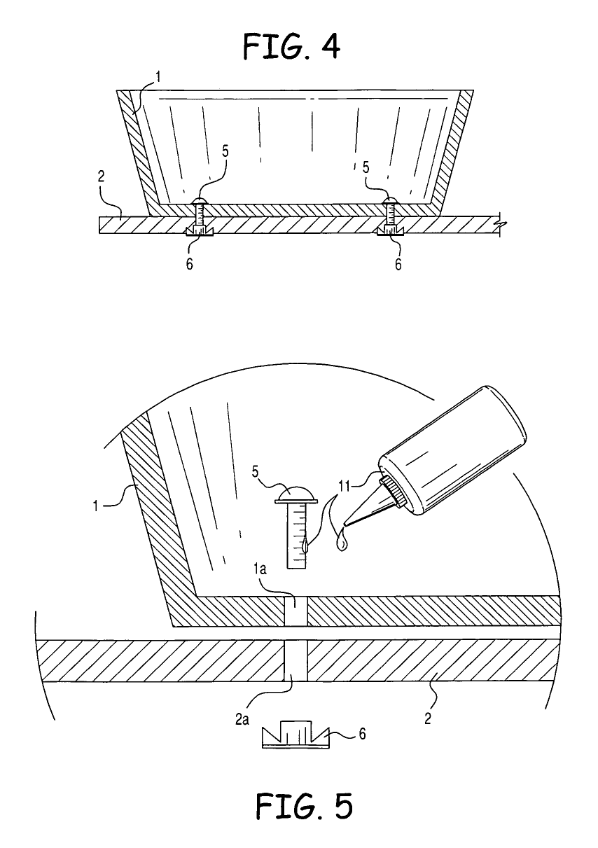

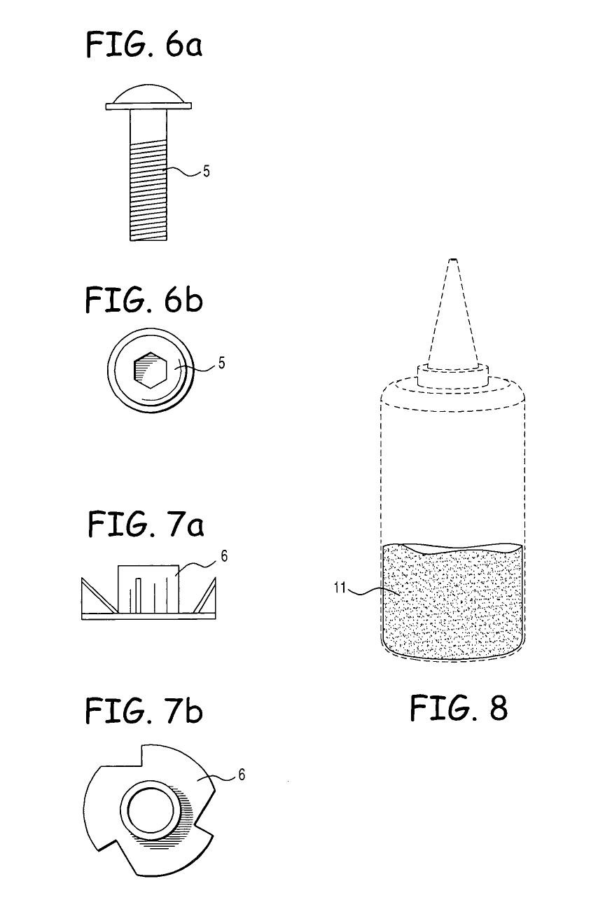

Side Elevation View (FIG. 2A)—This side elevation view shows the approximate thickness and length of the mat 1, and the height and positioning of the bowl 2. This view is the same for both a mat/bowl produced using a mold and for one assembled by attaching the mat 1 and bowl 2 together with fasteners.

Exploded View (FIG. 2B)—This is an exploded side elevation view of the mat/bowl where the mat 1 and bowl 2 begin as two independent pieces and are fastened together with five nuts 3 and bolts 4.

### DETAILED DESCRIPTION OF THE INVENTION

FIG. 1 is a top view of the mat/bowl horse and livestock feeder. Dashed lines indicate the outside measurements of the length and width of the mat 1, 44 inches in length and 40 inches at its widest point. The circular shape is the location and approximate size of the bowl 2 on the mat 1. Both the mat 1 and bowl 2 can vary in size as well as shape, but the most relevant characteristic is the size of the mat 1 in relation and proportion to the location and size of the bowl 2. This view of the drawing is an accurate depiction of the mat/bowl produced from a mold or requiring assembly.

FIG. 2A is a side elevation view of the mat/bowl. It shows the approximate length and thickness of the mat 1. It also shows the approximate location of the bowl 2 in relation to the surface of the mat 1. This view of the drawing is an accurate depiction of both the mat/bowl produced from a mold or requiring assembly.

FIG. 2B is an exploded side view of the mat/bowl assembled with fasteners. In this drawing, the bowl 2 is mounted to the mat 1 using five nuts 3 and bolts 4 spaced evenly apart from each other inside the bowl 2, along the outer edge.

1. (canceled)

2. (canceled)

3. (canceled)

4. (canceled)

5. (canceled)

6. (canceled)

7. (canceled)

8. An equine ground feeder for supporting horse during feeding, said feeder comprising,
a mat, said mat made of a material including rubber, said mat supporting two of the horses legs during use, and
a pan, said pan connected to said mat, said pan having a diameter of at least 16 inches, said pan having a wall, said wall having a height of at least 7 inches and a minimum capacity of at least three gallons.

9. The equine feeder as recited in claim 8, said equine feeder mat having a tear drop shape.

10. The equine feeder as recited in claim 8, said equine feeder mat having cutouts.

11. The equine feeder as recited in claim 8, said equine feeder mat made from recycled rubber and polyurethane glue.

12. The equine feeder as recited in claim 8, said equine feeder pan made of rubber.

13. The equine feeder as recited in claim 8, said equine feeder pan and said mat connected by glue.

14. The equine feeder as recited in claim 8, said equine feeder pan and said mat connected by screws.

15. An equine ground feeder for supporting a horse during feeding, said feeder comprising,
a mat, said mat made of a material including rubber and polyurethane glue, said mat supporting at least two of the horse's legs during use, and
a pan, said pan connected to said mat, said pan having a diameter of at least 16 inches, said pan having a wall, said wall having a height of at least 7 inches.

16. The equine feeder as recited in claim 15, said equine feeder mat having a tear drop shape.

17. The equine feeder as recited in claim 15, said equine feeder mat having cutouts.

18. The equine feeder as recited in claim 15, said equine feeder mat made from recycled rubber and polyurethane glue.

19. The equine feeder as recited in claim 15, said equine feeder pan made of rubber.

20. The equine feeder as recited in claim 15, said equine feeder pan and said mat connected by glue.

21. The equine feeder as recited in claim 8, said equine feeder pan and said mat connected by screws.

22. An equine ground feeder for supporting a horse during feeding, said feeder comprising,
a mat, said mat made of a material including rubber, and
a pan, said pan connected to said mat, said pan having a diameter of at least 16 inches, said pan having a wall, said wall having a height of at least 7 inches and a minimum capacity of at least three gallons.

23. The equine feeder as recited in claim 22, said equine feeder mat having a tear drop shape.

24. The equine feeder as recited in claim 22, said equine feeder mat having cutouts.

25. The equine feeder as recited in claim 22, said equine feeder mat made from recycled rubber and polyurethane glue.

26. The equine feeder as recited in claim 22, said equine feeder pan made of rubber.

27. The equine feeder as recited in claim 22, said equine feeder pan and said mat connected by glue.

28. The equine feeder as recited in claim 22, said equine feeder pan and said mat connected by screws.
